(19) United States
(12) Patent Application Publication
(10) Pub. No.: US 2026/0059423 A1
(43) Pub. Date: Feb. 26, 2026

(54) POWER EFFICIENT TRANSMISSION AND SCHEDULING OF COOPERATIVE DEVICES IN THE UPLINK

(71) Applicant: Telefonaktiebolaget LM Ericsson (publ), Stockholm (SE)

(72) Inventors: Mårten ERICSON, GAMMELSTAD (SE); Jan CHRISTOFFERSSON, LULEÅ (SE); Stefan WÅNSTEDT, LULEÅ (SE)

(73) Assignee: Telefonaktiebolaget LM Ericsson (publ), Stockholm (SE)

(21) Appl. No.: 19/104,805

(22) PCT Filed: Sep. 6, 2022
(86) PCT No.: PCT/SE2022/050790

§ 371 Date: Feb. 19, 2025

(51) Int. Cl. H04W 40/12; H04W 24/08; H04W 72/1268

(52) U.S. Cl. CPC H04W 40/12; H04W 24/08; H04W 72/1268

(57) ABSTRACT

A user equipment, UE, method, computer program, and computer program product for scheduling a group data transmission in a group of devices referred to as group devices is provided. The method includes transmitting data to the group devices over a sidelink at a first time. The method includes transmitting a minimum radio quality threshold to the group devices with the data for each group device to compare the group device's quality to the minimum radio quality threshold at a coordinated transmission time. The method includes cooperatively transmitting the data towards a network node at the coordinated transmission time based on the group device quality being above the minimum radio quality threshold on either a configured grant or a dynamically scheduled grant. An analogous network node, method, computer program, and computer program product are also provided.

### TECHNICAL FIELD

The present disclosure relates generally to communications, and more particularly to communication methods and related devices and nodes supporting wireless communications.

### BACKGROUND

### Cooperative Transmissions

D2D (device-to-device) cooperative group communication may be a way to increase the uplink coverage and user bit rate for example in a future high frequency 5G network. Recent work in the 3rd Generation Partnership Project (3GPP) is about side-link multi-path, which is closely related cooperative transmission (see e.g., RP-213585 WID on NR sidelink relay enhancements).

On a high level, a group of user equipments (UEs) (or sensors) are D2D capable, and when a UE with data to transmit will first distribute this data to neighboring UEs in the group over D2D or sidelink (SL). In a second step, the UEs in the group will cooperatively transmit the data over the cellular uplink (UL) links. In this way, the cooperative transmission would increase the UL coverage e.g., by combining transmissions from several UEs and would be also beneficial from a latency point of view compared to repeated transmissions for coverage (as used e.g., in LTE narrowband).

The very basic idea of the D2D cooperative group communication are as follows (see FIG. 1). When one UE in the group wants to transmit data through the group, it sends its data over the sidelink to the other users in the group, see left hand side of FIG. 1. Thereafter (2nd hop) the data is sent in a synchronized manner from the UEs in the group over the cellular UL to the network node (eNB/gNB), see right hand side of FIG. 1.

In the downlink (DL), the network transmits data to the group as if the group was a single UE. At least one UE in the group must be able to receive the DL data. If necessary, the DL data is relayed to the other UEs in the group via D2D.

This technique is not an entirely new technique and it is also known as cooperative relaying or Virtual Antenna Array. Also, there exists support for the D2D group communication concept to some extent in LTE (long term evolution) 3GPP. It is for example possible to create groups of UEs transmitting to each other. In 3GPP, this concept is called “Prose”, PROximity-based SErvices.

When a UE, assigned as a group coordinator, makes an attach/registration for itself, the UE can also make a combined attach/registration for a group of devices. The coordinator UE then also receives group identities such as the group-C-RNTI/TMSI (cell-radio network temporary identifier/temporary mobile subscriber identity). This also establishes the security keys which are used for encryption of the group bearers. When a group is later created (as in the current Prose standard), using ProSe Layer-2 Group ID, the coordinator UE sends to the UEs in the group the group TMSI/C-RNTI called group C-RNTI from hereon) and the security keys needed for cellular group transmission. The procedure is illustrated in FIG. 2.

Turning to FIG. 2, in step 1, the UE2, the UE3, and the UE coordinator creates a group, which in the current Prose standard is a Prose group. In step 2, the UE coordinator attaches/registers the group using the UE coordinator's identification. In step 3, the UE coordinator broadcasts the group C-RNTI received in the registration to the group of devices (i.e., UE2 and UE3 in FIG. 2).

A problem for the network base station is how to identify the source UE and a problem for the group members is how they can know if the data from the source UE shall be used for group transmission. One solution is to add a new source UE field with an indication for a 2^{nd} hop to the cellular network. When the members of the group are made aware that there is data that shall be transmitted cooperatively, all UEs in the group shall use a new group C-RNTI for the 2^{nd} hop transmission to the e/gNB, see FIG. 3 that shows the 2^{nd} hop destination and the group C-RNTI.

When the network node receives the data from the group, the network node thereafter forwards the data using the source UE's bearers, i.e., the network node makes a switch from the group bearer (over the Uu interface) to the (source) UE's own bearers/interfaces.

### Sidelink Transmissions in NR (New Radio)

One way to do D2D transmissions is to utilize sidelink (SL) transmissions over NR as specified for Rel-16. The method is an enhancement of the ProSe (PROximity-based SErvices) specified for LTE. The SL can be used for cooperative transmissions as described above. Four enhancements are introduced to NR sidelink transmissions:
Support for unicast and groupcast transmissions. For unicast and groupcast, a physical sidelink feedback channel (PSFCH) is introduced for a receiving UE to reply to the decoding status to a transmitting UE.
Grant-free transmissions, which are adopted in NR uplink transmissions, are also provided in NR sidelink transmissions, to improve the latency performance.
New design of a physical sidelink shared channel (PSCCH). To alleviate resource collisions among different sidelink transmissions launched by different UEs, it enhances channel sensing and resource selection procedures.
Support for QoS (Quality of Service). To achieve a high connection density, congestion control and QoS management are supported.

To enable the above enhancements, new physical channels and reference signals are introduced in NR (already available in LTE):
PSSCH (Physical Sidelink Shared Channel, SL version of PDSCH): The PSSCH is transmitted by a sidelink transmitting UE, which conveys sidelink transmission data, system information blocks (SIBs) for radio resource control (RRC) configuration, and a part of the sidelink control information (SCI).
PSFCH (Physical Sidelink, SL version of PUCCH): The PSFCH is transmitted by a sidelink receiving UE for unicast and groupcast, and conveys 1 bit information over 1 RB (resource block) for HARQ (hybrid automatic repeat request) acknowledgement (ACK) and not acknowledged (NACK). Channel state information (CSI) is carried in the medium access control (MAC) control element (CE) over the PSSCH instead of the PSFCH.
PSCCH (Physical Sidelink Common Control Channel, SL version of PDCCH): When the traffic to be sent to a receiving UE arrives at a transmitting UE, a transmitting UE should first send the PSCCH, which conveys a part of SCI (Sidelink Control information, SL version of DCI (downlink control information)) to be decoded by any UE for the channel sensing purpose, including the reserved time-frequency resources for transmissions, demodulation reference signal (DMRS) pattern and antenna port, etc.
Sidelink Primary/Secondary Synchronization Signal (SPSS/SSSS): Similar to downlink transmissions in NR, in sidelink transmissions, primary and secondary synchronization signals (called SPSS and SSSS, respectively) are supported. Through detecting the SPSS and SSSS, a UE is able to identify the sidelink synchronization identity (SSID) from the UE sending the SPSS/SSSS. Through detecting the SPSS/SSSS, a UE is therefore able to know the characteristics of the UE transmitting the SPSS/SSSS. A series of process of acquiring timing and frequency synchronization together with SSIDs of UEs is called initial cell search. Note that the UE sending the SPSS/SSSS may not be necessarily involved in sidelink transmissions, and a node (UE/eNB/gNB) sending the SPSS/SSSS is called a synchronization source.
Physical Sidelink Broadcast Channel (PSBCH): The PSBCH is transmitted along with the SPSS/SSSS as a synchronization signal/PSBCH block (SSB). The SSB has the same numerology as PSCCH/PSSCH on that carrier, and an SSB should be transmitted within the bandwidth of the configured BWP (bandwidth part). The PSBCH conveys information related to synchronization, such as the direct frame number (DFN), indication of the slot and symbol level time resources for sidelink transmissions, in-coverage indicator, etc. The SSB is transmitted periodically at every 160 ms. Further on, the PSBCH carries signaling information used for synchronization in the out-of-coverage or partial coverage scenario, or for synchronization between UEs located in different cells. It is connected with the SL Broadcast Channel (SL-BCH), a transport channel with a predefined transport format, which is possible because the blocks from the SBCCH are all of the same size. The SL-BCH interfaces with the Physical SL Broadcast Channel, the PSBCHDMRS, phase tracking reference signal (PT-RS), channel state information reference signal (CSIRS): These physical reference signals supported by NR downlink/uplink transmissions are also adopted by sidelink transmissions. Similarly, the PT-RS is only applicable for FR2 transmission.

Another new feature is the two-stage sidelink control information (SCI). This a version of the DCI for SL. Unlike the DCI, only part (first stage) of the SCI is sent on the PSCCH. This part is used for channel sensing purposes (including the reserved time-frequency resources for transmissions, demodulation reference signal (DMRS) pattern and antenna port, etc.) and can be read by all UEs while the remaining (second stage) scheduling and control information such as a 8-bits source identity (ID) and a 16-bits destination ID, NDI (new data indicator), RV (redundancy version) and HARQ process ID is sent on the PSSCH to be decoded by the receiving UE.

Similar to PROSE in LTE, NR sidelink transmissions have the following two modes of resource allocations:
Mode 1: Sidelink resources are scheduled by a gNB.
Mode 2: The UE autonomously selects sidelink resources from a (pre-) configured sidelink resource pool(s) based on the channel sensing mechanism.

For the in-coverage UE, a gNB can be configured to adopt Mode 1 or Mode 2. For the out-of-coverage UE, only Mode 2 can be adopted.

As in LTE, scheduling over the sidelink in NR is done in different ways for Mode 1 and Mode 2.

Mode 1 supports the following two kinds of grants:

Dynamic grant: When the traffic to be sent over sidelink arrives at a transmitting UE, the transmitting UE should launch the four-message exchange procedure to request sidelink resources from a gNB (SR (scheduling request) on UL, grant, BSR (buffer status report) on UL, grant for data on SL sent to UE). During the resource request procedure, a gNB may allocate a sidelink radio network temporary identifier (SL-RNTI) to the transmitting UE. If this sidelink resource request is granted by a gNB, then a gNB indicates the resource allocation for the PSCCH and the PSSCH in the downlink control information (DCI) conveyed by PDCCH with CRC (cyclic redundancy check) scrambled with the SL-RNTI. When a transmitting UE receives such a DCI, the transmitting UE can obtain the grant only if the scrambled CRC of DCI can be successfully solved by the assigned SL-RNTI. A transmitting UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitting UE can only transmit a single TB (transport block). As a result, this kind of grant is suitable for traffic with a loose latency requirement.

Configured grant: For the traffic with a strict latency requirement, performing the four-message exchange procedure to request sidelink resources may induce unacceptable latency. In this case, prior to the traffic arrival, a transmitting UE may perform the four-message exchange procedure and request a set of resources. If a grant can be obtained from a gNB, then the requested resources are reserved in a periodic manner. Upon traffic arriving at a transmitting UE, the transmitting UE can launch the PSCCH and the PSSCH on the upcoming resource occasion. In fact, this kind of grant is also known as grant-free transmissions.

In both dynamic grant and configured grant, a sidelink receiving UE cannot receive the DCI (since it is addressed to the transmitting UE), and therefore a receiving UE should perform blind decoding to identify the presence of PSCCH and find the resources for the PSSCH through the SCI.

When a transmitting UE launches the PSCCH, CRC is also inserted in the SCI without any scrambling.

In the Mode 2 resource allocation, when traffic arrives at a transmitting UE, this transmitting UE should autonomously select resources for the PSCCH and the PSSCH. To further minimize the latency of the feedback HARQ ACK/NACK transmissions and subsequently retransmissions, a transmitting UE may also reserve resources for PSCCH/PSSCH for retransmissions. To further enhance the probability of successful TB decoding at one shot and thus suppress the probability to perform retransmissions, a transmitting UE may repeat the TB transmission along with the initial TB transmission. This mechanism is also known as blind retransmission. As a result, when traffic arrives at a transmitting UE, then this transmitting UE should select resources for the following transmissions:
1) The PSSCH associated with the PSCCH for initial transmission and blind retransmissions.
2) The PSSCH associated with the PSCCH for retransmissions.

Since each transmitting UE in sidelink transmissions should autonomously select resources for above transmissions, how to prevent different transmitting UEs from selecting the same resources turns out to be a critical issue in Mode 2. A particular resource selection procedure is therefore imposed to Mode 2 based on channel sensing. The channel sensing algorithm involves measuring RSRP on different subchannels and requires knowledge of the different UEs power levels of DMRS on the PSSCH or the DMRS on the PSCCH depending on the configuration. This information is known only after receiving SCI launched by (all) other UEs. The sensing and selection algorithm is rather complex.

### Current Sidelink IDs

In order to identify the transmitting UE and the group for which the data packet is intended, two identities are provided in each message:
ProSe UE ID
ProSe Layer-2 Group ID

These IDs are either provided by the network or may be preconfigured in the UE. The ProSe UE ID has a length of 24 bits and is used in each MAC PDU (medium access control protocol data unit) as Source field. The ProSe Layer-2 Group ID is used to identify the group and has also a length of 24 bit. Its 8 LSBs are used in the control channel to filter data packets at the physical layer, and its 16 MSBs in a MAC PDU to identify the destination group. Together with the logical channel ID, the ProSe UE ID and the 16 MSBs of the ProSe Layer-2 Group ID identify the PDCP/RLC pair to be used in the receiving UE.

### SUMMARY

There currently exist certain challenge(s). A group of cooperating devices can improve the throughput and coverage for the involved devices. However, a problem is that the power consumption may be increased for some devices in the group. This can be mitigated by lowering the power used for the cooperative transmission, but this also lowers the benefit of the cooperative transmission, so the problem is not really solved.

In numerous scenarios, the capabilities of devices differ, both with respect to battery and transmission performance (e.g., sensors and UEs and also the device location). It can therefore happen that some UEs/sensors will run a risk of draining its battery without contributing significantly to the overall performance of the cooperative transmissions. It is therefore of importance to have methods to control and balance the transmission performance of the cooperative transmission and battery usage of the participating devices.

Certain aspects of the disclosure and their embodiments may provide solutions to these or other challenges. A cooperative scheduling method is provided that reduces the power consumption. This can be done via signalling in a group to exclude certain devices that contribute the least to the cooperative transmission performance.

In some embodiments, this scheduling can be controlled by a radio quality threshold that is included in the header of the data of the side link transmission to the group users. The group devices can then check their own quality and compare this to the threshold. If the quality is exceeded, they can take part in the UL cooperative transmission. If the quality is lower than the threshold, they should not participate in the UL cooperative transmission.

In other embodiments, the coordinator UE can collect quality and battery information of the group UEs and thereafter send a scheduling “bitmap” which indicates if the group UE shall be part of the next UL cooperative transmission. The scheduling can also be done by the gNB which gives the gNB an opportunity to tune the cooperative transmissions so that they reach the needed quality at the receiving gNB while at the same time minimize the power consumption.

According to some embodiments, a method in a user equipment, UE, for scheduling a group data transmission in a group of devices referred to as group devices includes transmitting data to the group devices over a sidelink at a first time. The method includes transmitting a minimum radio quality threshold to the group devices with the data for each group device to compare the group device's quality to the minimum radio quality threshold at a coordinated transmission time. The method includes cooperatively transmitting the data towards a network node at the coordinated transmission time based on the group device quality being above the minimum radio quality threshold on either a configured grant or a dynamically scheduled grant.

According to some other embodiments, a method in a user equipment, UE, for participating in a group data transmission in a group of devices referred to as group devices includes receiving data from a coordinator group device over a sidelink at a first time. The method includes receiving a minimum radio quality threshold. The method includes comparing a quality of the UE to the minimum radio quality threshold at a coordinated transmission time. The method includes determining whether to transmit the data towards a network node at the coordinated transmission time based on the quality of the UE being above the minimum radio quality threshold. The method includes responsive to determining to cooperatively transmit the data, transmitting the data towards a network node at the coordinated transmission time.

Analogous UEs, computer programs, and computer program products to the above embodiments are also provided.

According to further embodiments, a method in a network node for scheduling a group data transmission in a group of devices referred to as group devices includes receiving battery status from devices in the group devices. The method includes determining a transmission scheme that defines which devices of the group devices that participate in the group data transmission and a number of retransmissions to be used in transmitting the data. The method includes transmitting an indication to devices of the group devices that at least one of: indicates that the device does not need to participate in the coordinated transmission; or indicates that the device may participate in the coordinated transmission. The method includes scheduling the uplink coordinated transmission time for the group devices.

Certain embodiments may provide one or more of the following technical advantage(s). The coordination of UEs involved in cooperative transmissions enables UEs to minimize or control the UEs' power consumptions. This will allow UEs that are not necessary for successful cooperative transmissions to refrain from transmitting and thereby save energy. The invention can take into account the need for power saving of individual UEs while still meeting the SINR (signal to interference plus noise ratio) target at the receiver.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic illustration of a 2-hop group where one UE (“source UE”) wants to transmit data through the group to a base station;

FIG. 2 is an illustration of steps for group registration and creation and how to achieve the group C-RNTI;

FIG. 3 is an illustration of a solution when the member of the group identifies that there are data that shall be transmitted cooperatively where all UEs in the group shall use a new group C-RNTI (based on the group TMSI) for the 2^{nd} hop transmission to the base station;

FIGS. 4 to 16 are flowcharts illustrating operations of a user equipment according to some embodiments;

FIGS. 17 to 22 are flow charts illustrating operations of a network node according to some embodiments;

FIG. 23 is a block diagram of a communication system in accordance with some embodiments;

FIG. 24 is a block diagram of a user equipment in accordance with some embodiments;

FIG. 25 is a block diagram of a network node in accordance with some embodiments;

FIG. 26 is a block diagram of a host computer communicating with a user equipment in accordance with some embodiments;

FIG. 27 is a block diagram of a virtualization environment in accordance with some embodiments; and

FIG. 28 is a block diagram of a host computer communicating via a base station with a user equipment over a partially wireless connection in accordance with some embodiments in accordance with some embodiments.

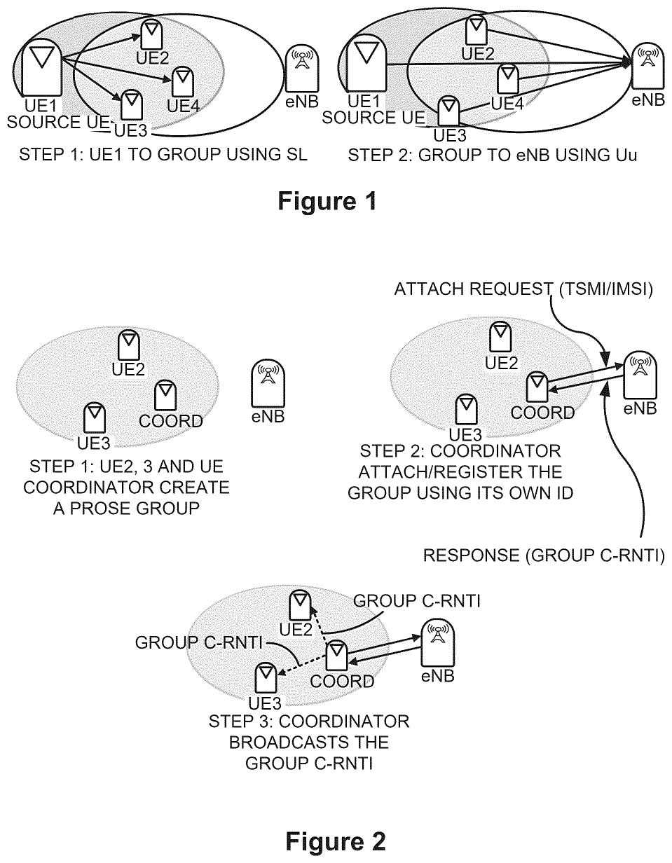

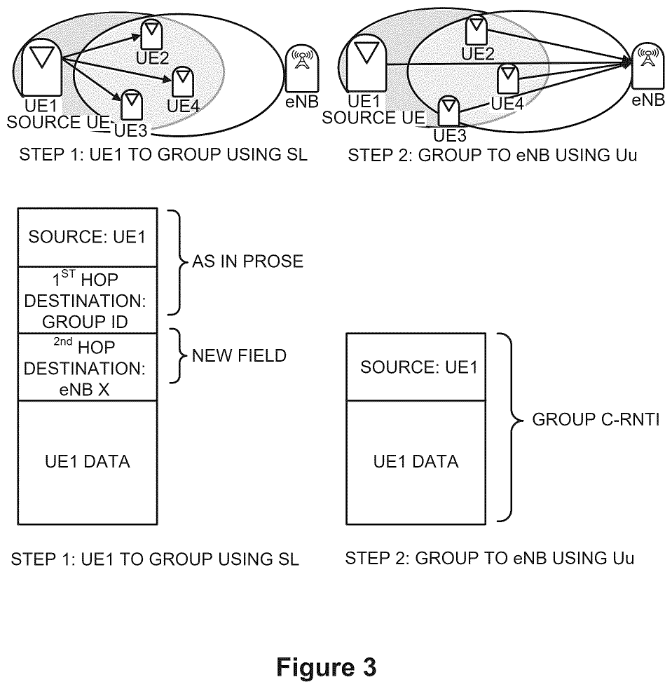

### DETAILED DESCRIPTION

Some of the embodiments contemplated herein will now be described more fully with reference to the accompanying drawings. Embodiments are provided by way of example to convey the scope of the subject matter to those skilled in the art., in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

As previously indicated, the capabilities of devices differs, both with respect to battery and transmission performance (e.g., sensors and UEs and also the device location). It can therefore happen that some UEs/sensors will run a risk of draining its battery without contributing significantly to the overall performance of the cooperative transmissions.

Various embodiments describe a cooperative scheduling method that may reduce the power consumption.

Prior to describing the various embodiments, a system overview shall be described. A cooperative group transmission in UL means that all users in the group transmit the same data simultaneously (using the same coding and transport block size) to the base station. The signals from all group users μ are then combined at the base station receiver b, creating a much better total SINR at the base station receiver, SINR_{b,total}:

$${SINR}_{b , total} = \sum {SINR}_{u} = \frac{\sum ( {P}_{u} \cdot {g}_{u , b} )}{I + Noise}$$

where SINRᵤ is the SINR of a group user, Pᵤ is the transmit power of each UE, g_{u,b} is the path gain from each UE to the base station, I is the interference from other cells, and Noise is the received noise.

However, as can be seen from the above formula, if one of the UEs in the group has a relatively low path gain (g_{u,b}), that UE will not contribute much to the total SINR_{b,total}.

With the above system overview as a background, in a first embodiment, a UE acts as a UE coordinator (i.e., a source UE). When the source UE sends data to the group devices over the sidelink at time T, the source UE also sends a minimum radio quality to the group devices. The minimum radio quality can, for example, be the SINR and/or the RSRP (reference signal received power) value of the source UE including some delta. At the cooperative transmission attempt at time T+t, (where t is the time between sidelink transmission and UL transmission) each group device checks (e.g., compares) its quality to the minimum quality and participates in the cooperative transmission if its own quality is above the threshold. If the group device's own quality is below the threshold, the group device refrains from transmitting and can thereby save battery.

Assume for example, that the minimum radio Quality is the SINR_{source} or the RSRP_{source} for the source UE plus some delta: Each group UE μ shall then when next UL group cooperative transmission at T+t is scheduled, check its own SINR or RSRP with the received minimum quality.

If the group UE's Qualityᵤ>Quality_{source}+delta, then the UE μ shall participate in the UL cooperative transmission.

Note that the UL SINR is not normally available by the UEs unless it has been signaled explicitly by the gNB. Therefore, the DL measurements can be used for the process above, which is typically available for the UE (since the DL measurement is done by the UE). For example, the DL RSRP is fairly reciprocal in DL and UL can easily be used for as the radio quality threshold. The DL RSRP can be translated or mapped to uplink, UL, SINR

The source UE therefore includes the radio quality threshold value together with which measurement the radio quality threshold is (DL RSRP, UL SINR, etc.), so each group device UE knows which type of value to use for the comparison.

The minimum radio Quality is valid for a certain time M ms, thus t must be lower than M to be valid, i.e., t<M. The time information can also be included in the sidelink Source UE transmission to the group.

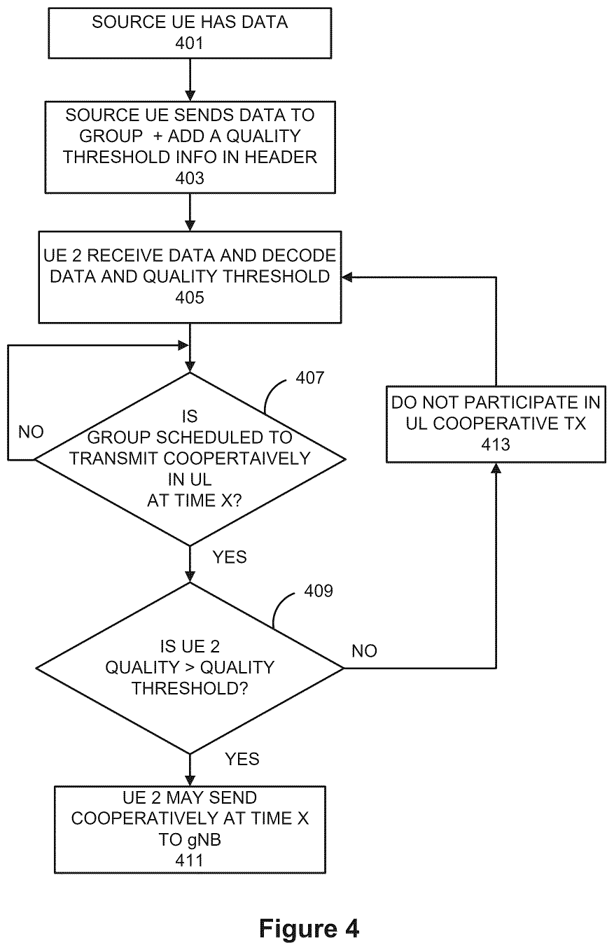

FIG. 4 is a flow chart for the minimum quality used in the UL cooperative transmission. Turning to FIG. 4, in block 401, the source UE has data for transmitting to the network node.

In block 403, the source UE sends the data to the group devices and adds radio quality threshold information in the header. The radio quality threshold information can be the radio quality threshold and the measurement to use.

In block 405, each group device (UE2 in FIG. 4) receives the data and decodes the data and radio quality threshold information.

The group devices may check the time in block 407 until the cooperative transmission time occurs. When the cooperative transmission time occurs, the group device checks its radio quality threshold in block 409 to determine if the group device's UE is greater than the radio quality threshold as described above.

If a group device's radio quality threshold is greater than the radio quality threshold, that group device may cooperatively send the data to the network node at time x. If that group device's radio quality threshold is not greater than the radio quality threshold, that group device proceeds to block 413 where that group device does not participate in the cooperative transmission.

The benefit of this embodiment is the simplicity and that the source UE is only asking for help from the UEs with good signal quality, i.e., UEs that will contribute significantly to the cooperative transmissions. The other UE may skip the cooperative transmission and save energy.

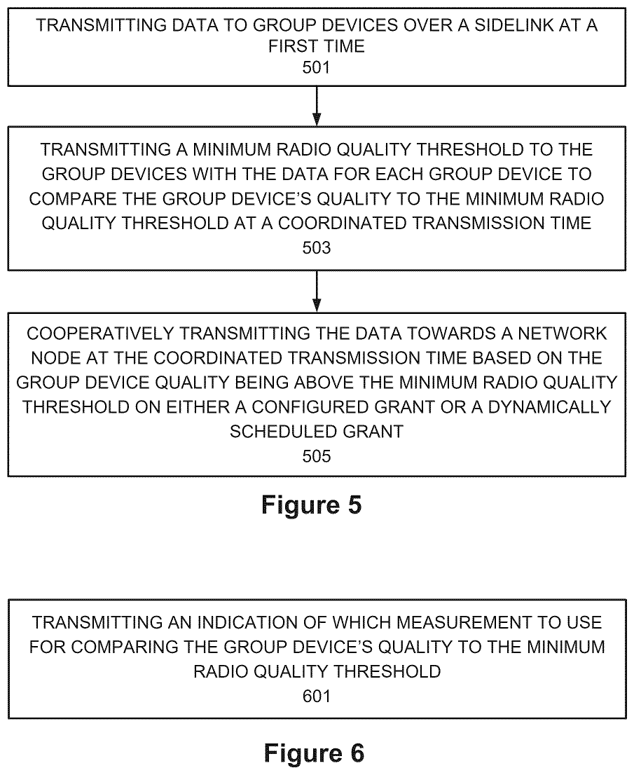

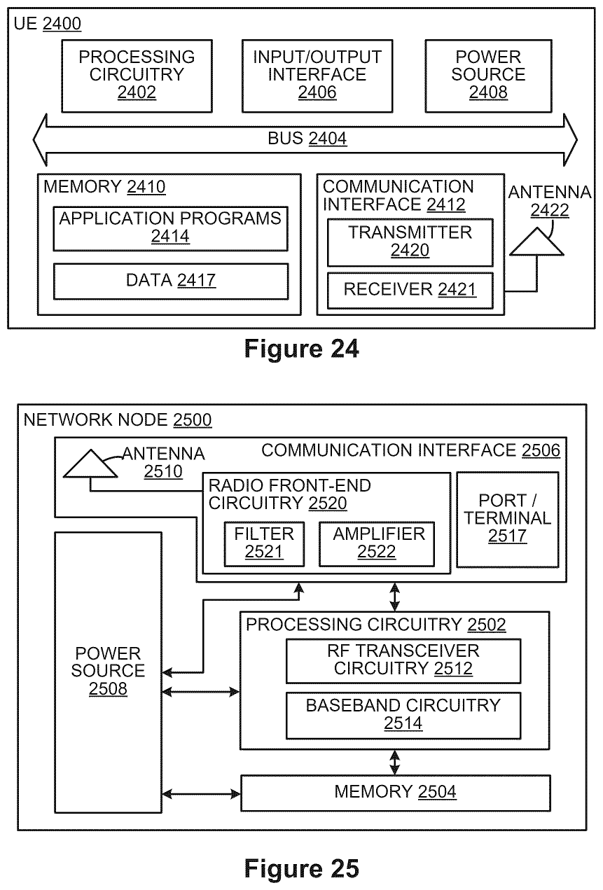

FIG. 5 is a flow chart illustrating operations of FIG. 4 from the perspective of the source UE. In the description of FIG. 5, the user equipment, UE, 2400 (implemented using the structure of the block diagram of FIG. 24) will be used to describe the flow chart of FIG. 5 according to some embodiments. For example, modules may be stored in memory 2410 of FIG. 24, and these modules may provide instructions so that when the instructions of a module are executed by respective communication device processing circuitry 2402, the communication device 2400 performs respective operations of the flow chart.

Turning to FIG. 5, in block 501, the UE 2400 transmits data to the group devices over a sidelink at a first time. In block 503, the UE 2400 transmits a minimum radio quality threshold to the group devices with the data for each group device to compare the group device's quality to the minimum radio quality threshold at a coordinated transmission time. In some embodiments, as illustrated by block 601 of FIG. 6, the UE 2400 transmits an indication of which measurement to use for comparing the group device quality to the minimum radio quality threshold.

Returning to FIG. 5, in block 505, the UE 2400 cooperatively transmits the data towards a network node at the coordinated transmission time based on the group device quality being above the minimum radio quality threshold on either a configured grant or a dynamically scheduled grant.

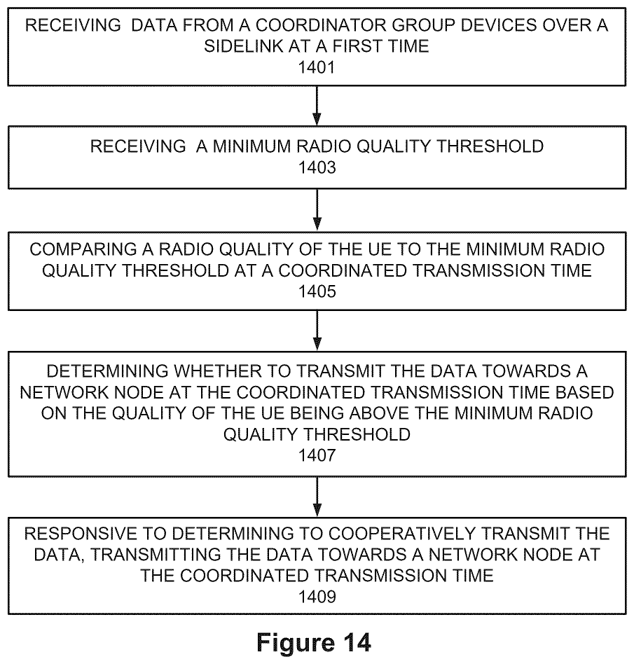

FIG. 14 illustrates operations of the group device in the flowchart of FIG. 4. The UE 2400 shall also be used to describe the operations of FIG. 14. Note that a coordinator UE (i.e., a source UE) in one group of devices may be just a group device in other groups. Turning to FIG. 14, in block 1401, the UE 2400 receives data from a coordinator group device over a sideline at a first time. In block 1402, the UE 2400 receives a minimum radio quality threshold. The UE 2400 may also receive an indication of which measurement to use with the minimum radio quality threshold.

In block 1405, the UE 2400 compares a radio quality of the UE 2400 to the minimum radio quality threshold at a coordinated transmission time. In block 1407, the UE 2400 determines whether to transmit the data towards a network node at the coordinated transmission time based on the quality of the UE 2400 being above the minimum radio quality threshold. For example, if the UE 2400's batter needs to be charged, the UE 2400 may decide not to participate in the coordinated transmission. If the quality of the UE 2400 is below the minimum radio quality threshold, the UE 2400 does not participate in the coordinated transmission.

In block 1409, responsive to determining to cooperatively transmit the data, the UE 2400 transmits the data towards a network node at the coordinated transmission time.

In some other embodiments, the coordinator UE controls the UL scheduling for the group devices. Just like above, one aspect of these other embodiments is to exclude devices that are not contributing to the transmission or devices that need to save battery.

The first step is that the network node configures the coordinator with the necessary total SINR threshold. This is the required total SINR for successful reception at the network node. In some of these embodiments, the required total SINR can be hardcoded for different modulation and coding schemes (MCS) and transport block size.

The network node can also configure the maximum allowable number of retransmissions to the UL cooperative transmission, which can be used in determining a transmission scheme.

All group devices send measurements or parameters to the coordinator UE in the form of:
Radio quality measurements, e.g., DL RSRP from group UEs or UL SINR from the network node to the coordinator UE.
Battery status for the group UEs. This can include amount of battery left, battery consumed during last x seconds or other indicator of the importance for a group UE to save battery. In the simplest form, it can be an indicator of whether the group UE needs to save battery.
The maximum allowed number of retransmissions

The coordinator UE determines a transmission scheme that defines which UEs that participate and the number of retransmissions that should be used. This is done to minimize and control the UEs power consumption in an optimal way. In this step the coordinator could do the following:
A. Sort the UEs with respect to priority to save battery, in high, medium and low priority groups where high priority indicates a highest need to save battery. This can be done by using how much of the device battery is left (0-100%), or an estimate of type of device (user, IoT device etc) and battery left.
B. Sort the UL SINR of the UEs with low priority to save battery
C. Starting with the UEs with highest UL SINR, sum the individual SINR for the UEs until the sum is at least required total SINR.
D. If the UEs needed to reach required total SINR still contain UEs that need to save battery, redo (B) with the assumption of one (additional) retransmission, as long as the number of retransmissions is less than the maximum allowed number of retransmissions.
E. If the required total SINR is not reached, add the UEs with next priority to save battery (e.g., the medium priority group first, then at last the high priority group)

When the number of UEs needed to reach the required total SINR with the minimum number of retransmissions has been obtained, the coordinator UE can thereafter send an indication to devices to either indicate the that the group device does not need to participate in the coordinated transmission or indicate that the group device may participate in the coordinated transmission. For example, the coordinator UE can send an inactive flag to group devices that do not need to participate in the coordinated transmission. This can be implemented as a bitmap broadcast.

If all UEs have the same importance of power saving, the coordinator or gNB can send the threshold (RSRP or SINR) to the UEs and the UEs themselves can determine whether to take part in the cooperative transmission.

The group UEs transmit on either a configured grant or a dynamically scheduled grant. The number of retransmissions can be indicated as repetitions in the dynamic grant.

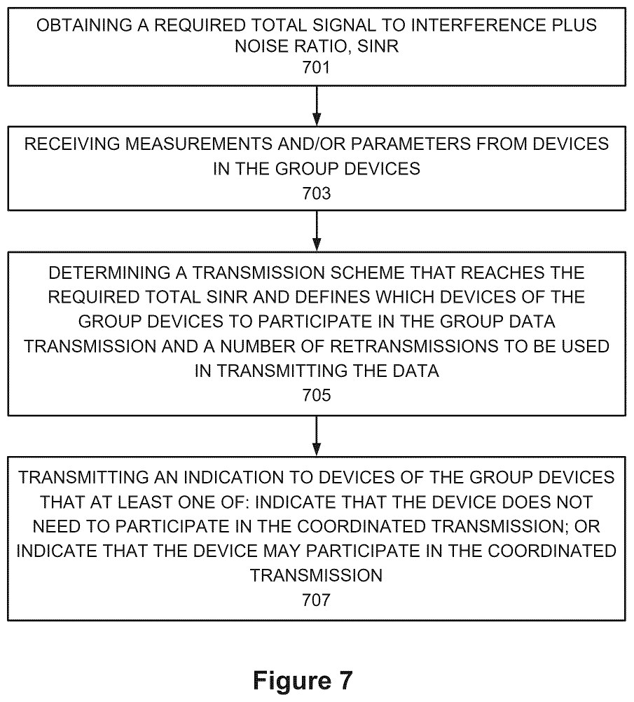

FIG. 7 is a flowchart illustrating operations the coordinator UE performs in coordinator controlled UL scheduling. In the description that follows, UE 2400 shall be used to describe the operations of the coordinator UE.

Turning to FIG. 7, in block 701, the UE 2400 obtains a required total signal to noise and interference ratio, SINR. For example, the UE 2400 may receive the total SINR from the network node 2500 or be configured with the total SINR.

In block 703, the UE 2400 receives measurements and/or parameters from devices in the group devices. As indicated above, the measurements and/or parameters may be in the form of:
Radio quality measurements, e.g., DL RSRP from group UEs to the coordinator UE.
Battery status for the group UEs. This can include amount of battery left, battery consumed during last x seconds or other indicator of the importance for a group UE to save battery. In the simplest form, it can be an indicator of whether the group UE needs to save battery.
The maximum allowed number of retransmissions

In block 705, the UE 2400 determines a transmission scheme that reaches the required total SINR and defines which devices of the group devices to participate in the group data transmission and a number of retransmissions to be used in transmitting the data

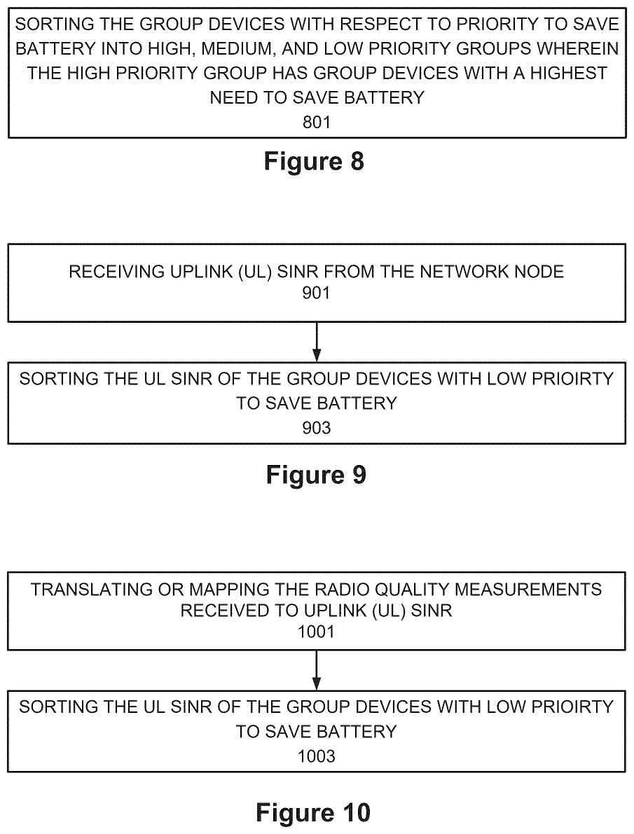

For example, the UE 2400 may, as indicated in block 801 of FIG. 8, sort the group devices with respect to priority to save battery into high, medium and low priority groups wherein the high priority group comprises group devices with a highest need to save battery. This can be done by using how much of the device battery is left (0-100%), or an estimate of type of device (user, IoT device etc.) and battery left.

In some embodiments, the UE 2400 receives uplink SINR (UL SINR) from the network node 2500 as illustrated in block 901 of FIG. 9. In block 903, the UE 2400 sorts the UL SINR of the group devices with low priority group to save battery.

In other embodiments, the UE 2400 translates or maps the radio quality measurements received to uplink, UL, SINR as illustrated in block 1001 of FIG. 10. In block 1003, the UE 2400 sorts the UL SINR of the group devices with low priority group to save battery.

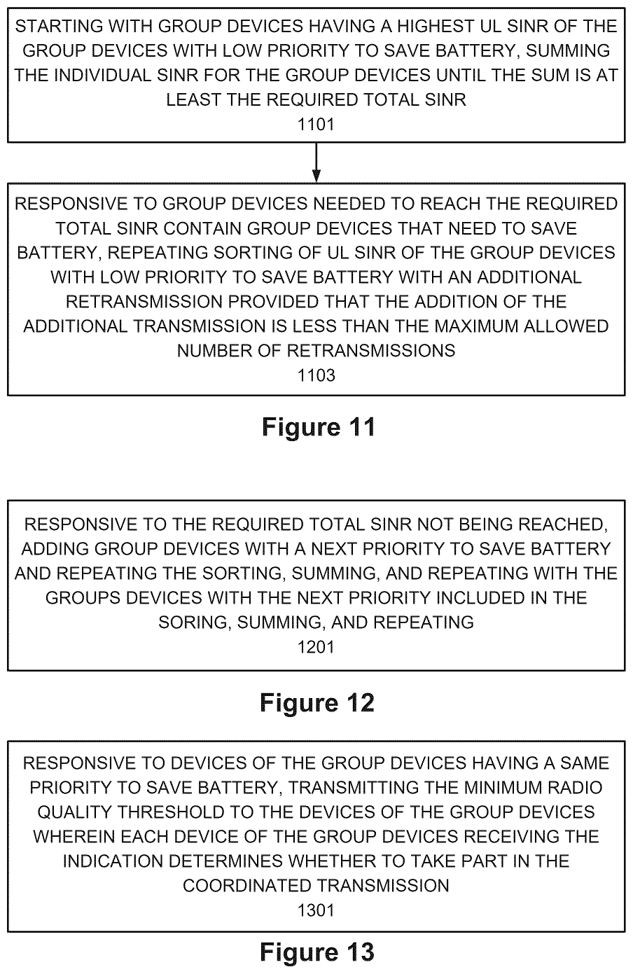

As illustrated in block 1101 of FIG. 11, the UE 2400, starting with group devices with a highest UL SINR of the group devices with low priority to save battery, sums the individual SINR for the group devices until the sum is at least the required total SINR.

The UE 2400, in block 1103, responsive to group devices needed to reach the required total SINR contain group devices that need to save battery, repeats sorting of UL SINR of the group devices with low priority to save battery with an additional retransmission provided that the addition of the additional transmission is less than the maximum allowed number of retransmissions.

In some scenarios, the group devices with low priority may not be enough to meet the total SINR. In some embodiments, as illustrated in block 1201 of FIG. 12, the UE 2400, responsive to the required total SINR not being reached, adds group devices with a next priority to save battery and repeating the sorting, summing, and repeating with the group devices with the next priority included in the sorting, summing, and repeating. For example, if the group devices with low priority are not enough, the UE 2400 adds group devices from the medium priority group and repeats the sorting, summing, and repeating operations of FIGS. 9-11. If the combination of groups devices with low priority and medium priority are not enough, the UE 2400 adds group devices from the high priority group and repeats the sorting, summing, and repeating.

Returning to FIG. 7, in block 707, the UE 2400 transmits an indication to devices of the group devices that at least one of: indicate that the device does not need to participate in the coordinated transmission; or indicate that the device may participate in the coordinated transmission.

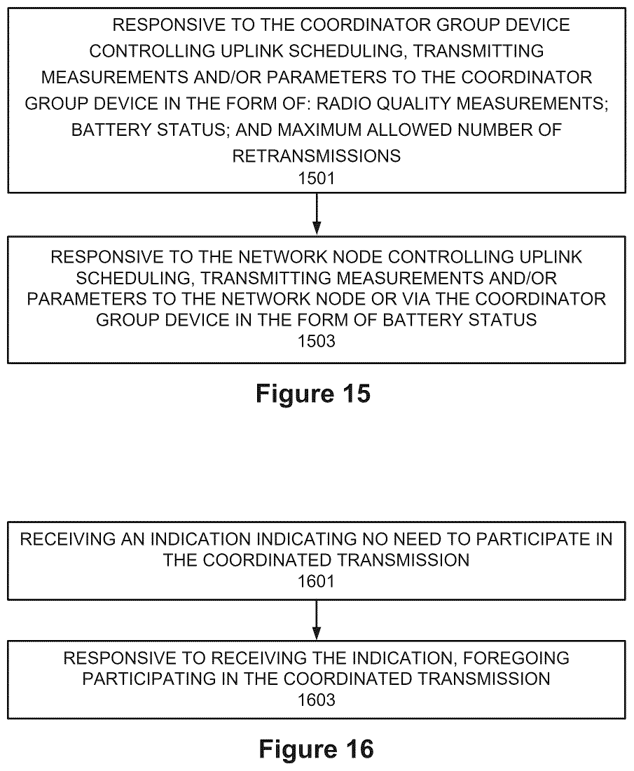

FIGS. 15 and 16 illustrate further operations a group device may perform when the coordinator UE or the network node 2500 controls UL scheduling. The UE 2400 shall be used to describe these operations.

FIG. 15 illustrates the types of measurements and/or parameters the UE 2400 provides to the coordinator UE or the network node. In block 1501, responsive to the coordinator group device controlling uplink scheduling, the UE 2400 transmits measurements and/or parameters to the coordinator group device in the form of: radio quality measurements, battery status, and maximum allowed number of retransmissions. In block 1503, responsive to the network node 2500 controlling uplink scheduling, the UE 2400 transmits measurements and/or parameters to the coordinator group device in the form of: battery status. The network node 2500 already knows the radio quality and the maximum number of retransmissions and thus does not need to receive these from the UE 2400.

FIG. 16 illustrates a UE 2400 receiving an indication of no need to participate in the coordinated transmission. Turning to FIG. 16, in block 1601, the UE 2400 receives an indication indicating no need to participate in the coordinated transmission. In some embodiments, the indication is an inactive flag. In block 1603, the UE 2400, responsive to receiving the indication, foregoes participating in the coordinated transmission.

In determining whether to transmit the data towards a network node, the UE 2400, determines whether to transmit the data towards a network node at the coordinated transmission time by determining whether to transmit the data towards a network node at the coordinated transmission time based on the quality of the UE being above the minimum radio quality threshold at the coordinated transmission time and not receiving the indication of no need to participate in the coordinated transmission.

As indicated above, the network node 2500 may control UL scheduling in some embodiments. The information exchanged with group devices is different.

In a first step in these embodiments, all group devices send battery status to the network node 2500, in one option the transmission is relayed via the coordinator UE. This “battery status” can, as above, include amount of battery left, battery consumed during last x seconds or some other indicator of the importance for a group UE to save battery. In the simplest form, it can be an indicator of whether the group UE needs to save battery, e.g., implemented as a threshold of, e.g., 20% of total battery capacity.

In this embodiment, the network node 2500 has knowledge of the individual SINRs and of course the total required SINR as well as a maximum acceptable number of retransmissions to reach the required total SINR. In some embodiments, this can be dependent on the QoS (quality of service) requirements, such as, e.g., latency.

The network node 2500 determines the transmission scheme defined by which UEs that participate and the number of retransmissions that should be used to minimize or control the UEs power consumption in an optimal way. The network node 2500 could do the following:
A. Sort the UEs with respect to priority to save battery, in high, medium and low priority groups where high priority indicates a highest need to save battery. This can be done by using how much of the device battery is left (0-100%), or an estimate of type of device (user, IoT device etc) and battery left.
B. Sort the UL SINR of the group UEs with low priority to save battery
C. Starting with the UEs with highest UL SINR, sum the individual SINR for the group UEs until the sum is at least required total SINR.
D. If the group UEs needed to reach required total SINR still contain group UEs that need to save battery, redo (B) with the assumption of one (additional) retransmission, as long as the number of retransmissions is less than the maximum allowed number of retransmissions.
E. If the required total SINR is not reached, add the UEs with next priority to save battery (e.g., the medium priority group first, then at last the high priority group)

When the number of group UEs needed to reach the required total SINR with the minimum number of retransmissions has been obtained, the network node 2500 can thereafter send an indication to devices to either indicate the that the group device does not need to participate in the coordinated transmission or indicate that the group device may participate in the coordinated transmission. For example, the network node 2500 can send an inactive flag to group devices that do not need to participate in the coordinated transmission. This can be implemented as a bitmap broadcast.

As a final operation, the network node 2500 can schedule the cooperative transmission.

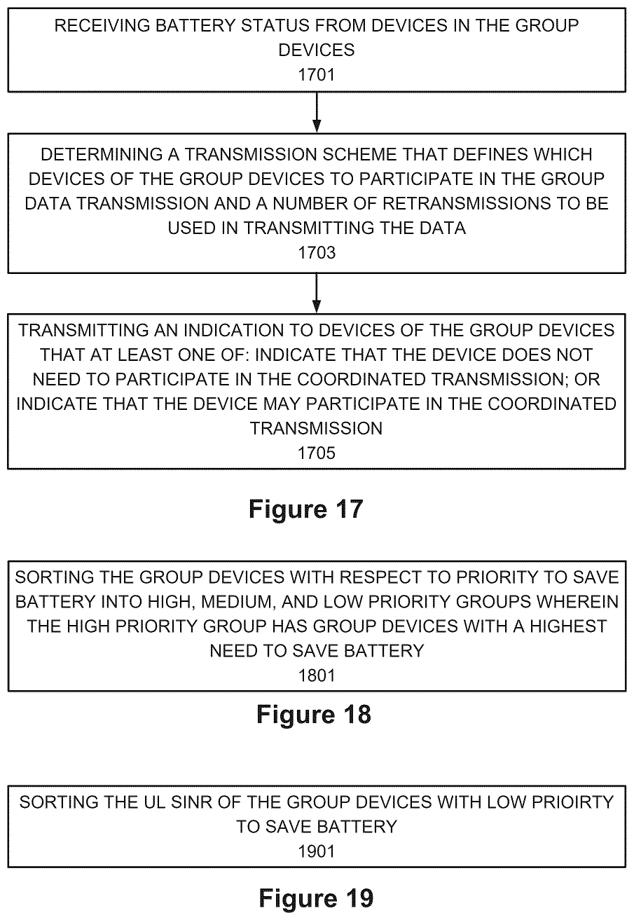

FIGS. 17-21 illustrate operations the network node 2500 performs. Operations of the network node 2500 (implemented using the structure of FIG. 24) will now be discussed with reference to the flow chart of FIG. 16 according to some embodiments of inventive concepts. For example, modules may be stored in memory 2504 of FIG. 25, and these modules may provide instructions so that when the instructions of a module are executed by respective network node processing circuitry 2502, the network node 2500 performs respective operations of the flow chart.

Turning to FIG. 17, the network node 2500, in block 1701, receives battery status from devices in the group devices. As previously indicated, this may be in the form of an amount of battery left, battery consumed during last x seconds or some other indicator of the importance for a group UE to save battery. In the simplest form, it can be an indicator of whether the group UE needs to save battery, e.g., implemented as a threshold of, e.g., 20% of total battery capacity.

In block 1703, the network node 2500 determines a transmission scheme that defines which devices of the group devices that participate in the group data transmission and a number of retransmissions to be used in transmitting the data.

For example, the network node 2500 may, as indicated in block 1801 of FIG. 18, sort the group devices with respect to priority to save battery into high, medium and low priority groups wherein the high priority group comprises group devices with a highest need to save battery. This can be done by using how much of the device battery is left (0-100%), or an estimate of type of device (user, IoT device etc.) and battery left.

In some embodiments, the network node 2500 sorts the UL SINR of the group devices with low priority group to save battery as illustrated in block 1901 of FIG. 19.

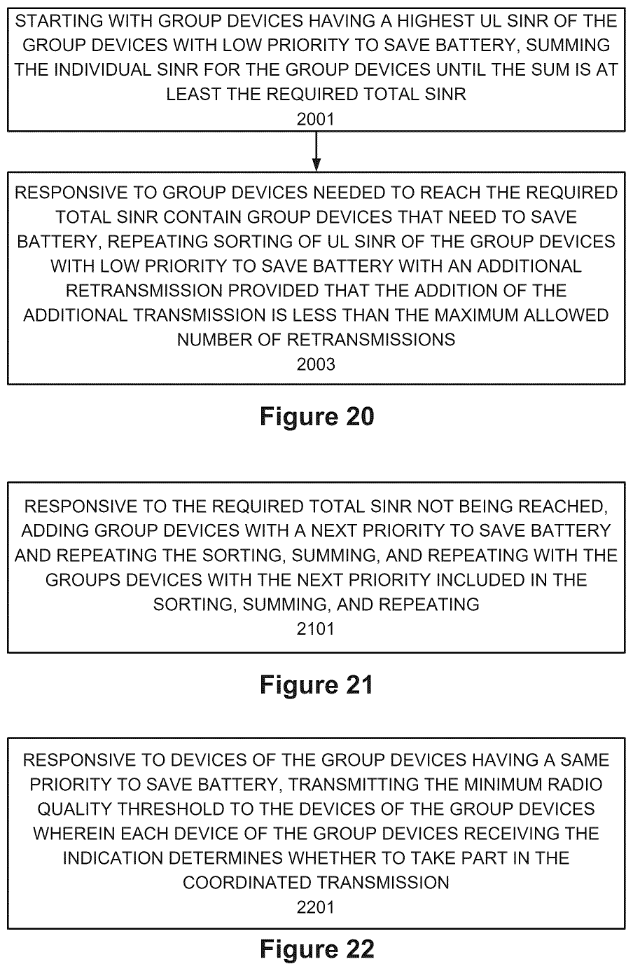

As illustrated in block 2001 of FIG. 20, the network node 2500, starting with group devices with a highest UL SINR of the group devices with low priority to save battery, sums the individual SINR for the group devices until the sum is at least the required total SINR.

The network node 2500, in block 2003, responsive to group devices needed to reach the required total SINR contain group devices that need to save battery, repeats sorting of UL SINR of the group devices with low priority to save battery with an additional retransmission provided that the addition of the additional transmission is less than the maximum allowed number of retransmissions.

In some scenarios, the group devices with low priority may not be enough to meet the total SINR. In some embodiments, as illustrated in block 2101 of FIG. 21, the network node 2500, responsive to the required total SINR not being reached, adds group devices with a next priority to save battery and repeating the sorting, summing, and repeating with the group devices with the next priority included in the sorting, summing, and repeating. For example, if the group devices with low priority are not enough, the network node 2500 adds group devices from the medium priority group and repeats the sorting, summing, and repeating operations of FIGS. 19-20. If the combination of groups devices with low priority and medium priority are not enough, the network node 2500 adds group devices from the high priority group and repeats the sorting, summing, and repeating.

Returning to FIG. 17, in block 1705, the network node 2500 transmits an indication to devices of the group devices that at least one of: indicate that the device does not need to participate in the coordinated transmission; or indicate that the device may participate in the coordinated transmission. The indication may be in the form of a bitmap broadcast to transmit the indication.

In some embodiments as illustrated in block 2201 of FIG. 22, responsive to devices of the group devices having a same priority to save battery, the indication may be in the form of transmitting the threshold to devices of the group devices wherein each device of the group devices receiving the indication determines whether to take part in the coordinated transmission.

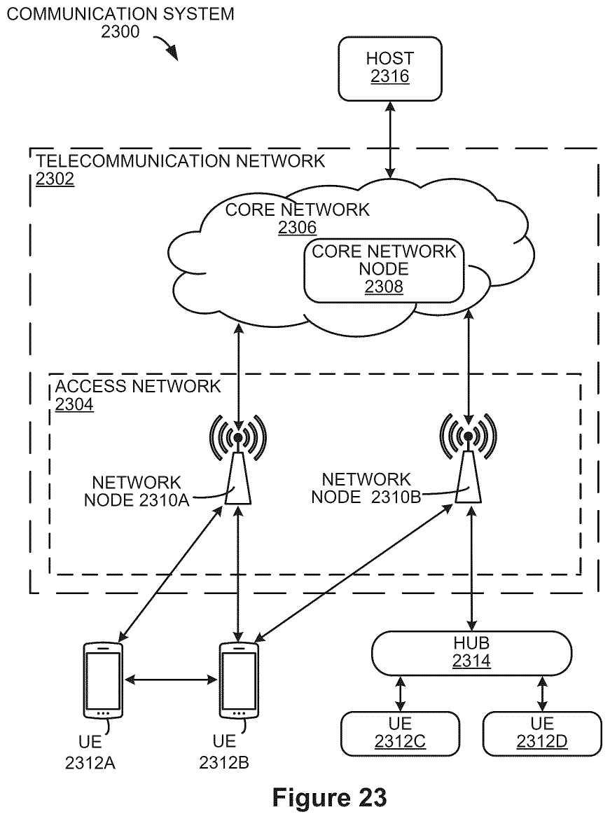

FIG. 23 shows an example of a communication system 2300 in accordance with some embodiments.

In the example, the communication system 2300 includes a telecommunication network 2302 that includes an access network 2304, such as a radio access network (RAN), and a core network 2306, which includes one or more core network nodes 2308. The access network 2304 includes one or more access network nodes, such as network nodes 2310A and 2310B (one or more of which may be generally referred to as network nodes 2310), or any other similar 3^{rd} Generation Partnership Project (3GPP) access node or non-3GPP access point. The network nodes 2310 facilitate direct or indirect connection of user equipment (UE), such as by connecting UEs 2312A, 2312B, 2312C, and 2312D (one or more of which may be generally referred to as UEs 2312) to the core network 2306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2300 may include any number of wired or wireless networks, network nodes, UEs, and/or any other components or systems that may facilitate or participate in the communication of data and/or signals whether via wired or wireless connections. The communication system 2300 may include and/or interface with any type of communication, telecommunication, data, cellular, radio network, and/or other similar type of system.

The UEs 2312 may be any of a wide variety of communication devices, including wireless devices arranged, configured, and/or operable to communicate wirelessly with the network nodes 2310 and other communication devices. Similarly, the network nodes 2310 are arranged, capable, configured, and/or operable to communicate directly or indirectly with the UEs 2312 and/or with other network nodes or equipment in the telecommunication network 2302 to enable and/or provide network access, such as wireless network access, and/or to perform other functions, such as administration in the telecommunication network 2302.

In the depicted example, the core network 2306 connects the network nodes 2310 to one or more hosts, such as host 2316. These connections may be direct or indirect via one or more intermediary networks or devices. In other examples, network nodes may be directly coupled to hosts. The core network 2306 includes one more core network nodes (e.g., core network node 2308) that are structured with hardware and software components. Features of these components may be substantially similar to those described with respect to the UEs, network nodes, and/or hosts, such that the descriptions thereof are generally applicable to the corresponding components of the core network node 2308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2316 may be under the ownership or control of a service provider other than an operator or provider of the access network 2304 and/or the telecommunication network 2302, and may be operated by the service provider or on behalf of the service provider. The host 2316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2300 of FIG. 23 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi (Light Fidelity), and/or any low-power wide-area network (LPWAN) standards such as LoRa (Long Range) and Sigfox.

In some examples, the telecommunication network 2302 is a cellular network that implements 3GPP standardized features. Accordingly, the telecommunications network 2302 may support network slicing to provide different logical networks to different devices that are connected to the telecommunication network 2302. For example, the telecommunications network 2302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT (Internet of Things) services to yet further UEs.

In some examples, the UEs 2312 are configured to transmit and/or receive information without direct human interaction. For instance, a UE may be designed to transmit information to the access network 2304 on a predetermined schedule, when triggered by an internal or external event, or in response to requests from the access network 2304. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 2314 communicates with the access network 2304 to facilitate indirect communication between one or more UEs (e.g., UE 2312C and/or 2312D) and network nodes (e.g., network node 2310B). In some examples, the hub 2314 may be a controller, router, content source and analytics, or any of the other communication devices described herein regarding UEs. For example, the hub 2314 may be a broadband router enabling access to the core network 2306 for the UEs. As another example, the hub 2314 may be a controller that sends commands or instructions to one or more actuators in the UEs. Commands or instructions may be received from the UEs, network nodes 2310, or by executable code, script, process, or other instructions in the hub 2314. As another example, the hub 2314 may be a data collector that acts as temporary storage for UE data and, in some embodiments, may perform analysis or other processing of the data. As another example, the hub 2314 may be a content source. For example, for a UE that is a VR headset, display, loudspeaker or other media delivery device, the hub 2314 may retrieve VR assets, video, audio, or other media or data related to sensory information via a network node, which the hub 2314 then provides to the UE either directly, after performing local processing, and/or after adding additional local content. In still another example, the hub 2314 acts as a proxy server or orchestrator for the UEs, in particular in if one or more of the UEs are low energy IoT devices.

The hub 2314 may have a constant/persistent or intermittent connection to the network node 2310B. The hub 2314 may also allow for a different communication scheme and/or schedule between the hub 2314 and UEs (e.g., UE 2312C and/or 2312D), and between the hub 2314 and the core network 2306. In other examples, the hub 2314 is connected to the core network 2306 and/or one or more UEs via a wired connection. Moreover, the hub 2314 may be configured to connect to an M2M service provider over the access network 2304 and/or to another UE over a direct connection. In some scenarios, UEs may establish a wireless connection with the network nodes 2310 while still connected via the hub 2314 via a wired or wireless connection. In some embodiments, the hub 2314 may be a dedicated hub—that is, a hub whose primary function is to route communications to/from the UEs from/to the network node 2310B. In other embodiments, the hub 2314 may be a non-dedicated hub—that is, a device which is capable of operating to route communications between the UEs and network node 2310B, but which is additionally capable of operating as a communication start and/or end point for certain data channels.

FIG. 24 shows a UE 2400 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3^{rd} Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2400 includes processing circuitry 2402 that is operatively coupled via a bus 2404 to an input/output interface 2406, a power source 2408, a memory 2410, a communication interface 2412, and/or any other component, or any combination thereof. Certain UEs may utilize all or a subset of the components shown in FIG. 24. The level of integration between the components may vary from one UE to another UE. Further, certain UEs may contain multiple instances of a component, such as multiple processors, memories, transceivers, transmitters, receivers, etc.

The processing circuitry 2402 is configured to process instructions and data and may be configured to implement any sequential state machine operative to execute instructions stored as machine-readable computer programs in the memory 2410. The processing circuitry 2402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2402 may include multiple central processing units (CPUs).

In the example, the input/output interface 2406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2408 is structured as a battery or battery pack. Other types of power sources, such as an external power source (e.g., an electricity outlet), photovoltaic device, or power cell, may be used. The power source 2408 may further include power circuitry for delivering power from the power source 2408 itself, and/or an external power source, to the various parts of the UE 2400 via input circuitry or an interface such as an electrical power cable. Delivering power may be, for example, for charging of the power source 2408. Power circuitry may perform any formatting, converting, or other modification to the power from the power source 2408 to make the power suitable for the respective components of the UE 2400 to which power is supplied.

The memory 2410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2410 includes one or more application programs 2414, such as an operating system, web browser application, a widget, gadget engine, or other application, and corresponding data 2416. The memory 2410 may store, for use by the UE 2400, any of a variety of various operating systems or combinations of operating systems.

The memory 2410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2410 may allow the UE 2400 to access instructions, application programs and the like, stored on transitory or non-transitory memory media, to off-load data, or to upload data. An article of manufacture, such as one utilizing a communication system may be tangibly embodied as or in the memory 2410, which may be or comprise a device-readable storage medium.

The processing circuitry 2402 may be configured to communicate with an access network or other network using the communication interface 2412. The communication interface 2412 may comprise one or more communication subsystems and may include or be communicatively coupled to an antenna 2422. The communication interface 2412 may include one or more transceivers used to communicate, such as by communicating with one or more remote transceivers of another device capable of wireless communication (e.g., another UE or a network node in an access network). Each transceiver may include a transmitter 2418 and/or a receiver 2420 appropriate to provide network communications (e.g., optical, electrical, frequency allocations, and so forth). Moreover, the transmitter 2418 and receiver 2420 may be coupled to one or more antennas (e.g., antenna 2422) and may share circuit components, software or firmware, or alternatively be implemented separately.

In the illustrated embodiment, communication functions of the communication interface 2412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2400 shown in FIG. 24.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 25 shows a network node 2500 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2500 includes a processing circuitry 2502, a memory 2504, a communication interface 2506, and a power source 2508. The network node 2500 may be composed of multiple physically separate components (e.g., a NodeB component and a RNC component, or a BTS component and a BSC component, etc.), which may each have their own respective components. In certain scenarios in which the network node 2500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2500 may be configured to support multiple radio access technologies (RATs). In such embodiments, some components may be duplicated (e.g., separate memory 2504 for different RATs) and some components may be reused (e.g., a same antenna 2510 may be shared by different RATs). The network node 2500 may also include multiple sets of the various illustrated components for different wireless technologies integrated into network node 2500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2500.

The processing circuitry 2502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2500 components, such as the memory 2504, to provide network node 2500 functionality.

In some embodiments, the processing circuitry 2502 includes a system on a chip (SOC). In some embodiments, the processing circuitry 2502 includes one or more of radio frequency (RF) transceiver circuitry 2512 and baseband processing circuitry 2514. In some embodiments, the radio frequency (RF) transceiver circuitry 2512 and the baseband processing circuitry 2514 may be on separate chips (or sets of chips), boards, or units, such as radio units and digital units. In alternative embodiments, part or all of RF transceiver circuitry 2512 and baseband processing circuitry 2514 may be on the same chip or set of chips, boards, or units.

The memory 2504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2502. The memory 2504 may store any suitable instructions, data, or information, including a computer program, software, an application including one or more of logic, rules, code, tables, and/or other instructions capable of being executed by the processing circuitry 2502 and utilized by the network node 2500. The memory 2504 may be used to store any calculations made by the processing circuitry 2502 and/or any data received via the communication interface 2506. In some embodiments, the processing circuitry 2502 and memory 2504 is integrated.

The communication interface 2506 is used in wired or wireless communication of signaling and/or data between a network node, access network, and/or UE. As illustrated, the communication interface 2506 comprises port(s)/terminal(s) 2516 to send and receive data, for example to and from a network over a wired connection. The communication interface 2506 also includes radio front-end circuitry 2518 that may be coupled to, or in certain embodiments a part of, the antenna 2510. Radio front-end circuitry 2518 comprises filters 2520 and amplifiers 2522. The radio front-end circuitry 2518 may be connected to an antenna 2510 and processing circuitry 2502. The radio front-end circuitry may be configured to condition signals communicated between antenna 2510 and processing circuitry 2502. The radio front-end circuitry 2518 may receive digital data that is to be sent out to other network nodes or UEs via a wireless connection. The radio front-end circuitry 2518 may convert the digital data into a radio signal having the appropriate channel and bandwidth parameters using a combination of filters 2520 and/or amplifiers 2522. The radio signal may then be transmitted via the antenna 2510. Similarly, when receiving data, the antenna 2510 may collect radio signals which are then converted into digital data by the radio front-end circuitry 2518. The digital data may be passed to the processing circuitry 2502. In other embodiments, the communication interface may comprise different components and/or different combinations of components.

In certain alternative embodiments, the network node 2500 does not include separate radio front-end circuitry 2518, instead, the processing circuitry 2502 includes radio front-end circuitry and is connected to the antenna 2510. Similarly, in some embodiments, all or some of the RF transceiver circuitry 2512 is part of the communication interface 2506. In still other embodiments, the communication interface 2506 includes one or more ports or terminals 2516, the radio front-end circuitry 2518, and the RF transceiver circuitry 2512, as part of a radio unit (not shown), and the communication interface 2506 communicates with the baseband processing circuitry 2514, which is part of a digital unit (not shown).

The antenna 2510 may include one or more antennas, or antenna arrays, configured to send and/or receive wireless signals. The antenna 2510 may be coupled to the radio front-end circuitry 2518 and may be any type of antenna capable of transmitting and receiving data and/or signals wirelessly. In certain embodiments, the antenna 2510 is separate from the network node 2500 and connectable to the network node 2500 through an interface or port.

The antenna 2510, communication interface 2506, and/or the processing circuitry 2502 may be configured to perform any receiving operations and/or certain obtaining operations described herein as being performed by the network node. Any information, data and/or signals may be received from a UE, another network node and/or any other network equipment. Similarly, the antenna 2510, the communication interface 2506, and/or the processing circuitry 2502 may be configured to perform any transmitting operations described herein as being performed by the network node. Any information, data and/or signals may be transmitted to a UE, another network node and/or any other network equipment.

The power source 2508 provides power to the various components of network node 2500 in a form suitable for the respective components (e.g., at a voltage and current level needed for each respective component). The power source 2508 may further comprise, or be coupled to, power management circuitry to supply the components of the network node 2500 with power for performing the functionality described herein. For example, the network node 2500 may be connectable to an external power source (e.g., the power grid, an electricity outlet) via an input circuitry or interface such as an electrical cable, whereby the external power source supplies power to power circuitry of the power source 2508. As a further example, the power source 2508 may comprise a source of power in the form of a battery or battery pack which is connected to, or integrated in, power circuitry. The battery may provide backup power should the external power source fail.

Embodiments of the network node 2500 may include additional components beyond those shown in FIG. 25 for providing certain aspects of the network node's functionality, including any of the functionality described herein and/or any functionality necessary to support the subject matter described herein. For example, the network node 2500 may include user interface equipment to allow input of information into the network node 2500 and to allow output of information from the network node 2500. This may allow a user to perform diagnostic, maintenance, repair, and other administrative functions for the network node 2500.

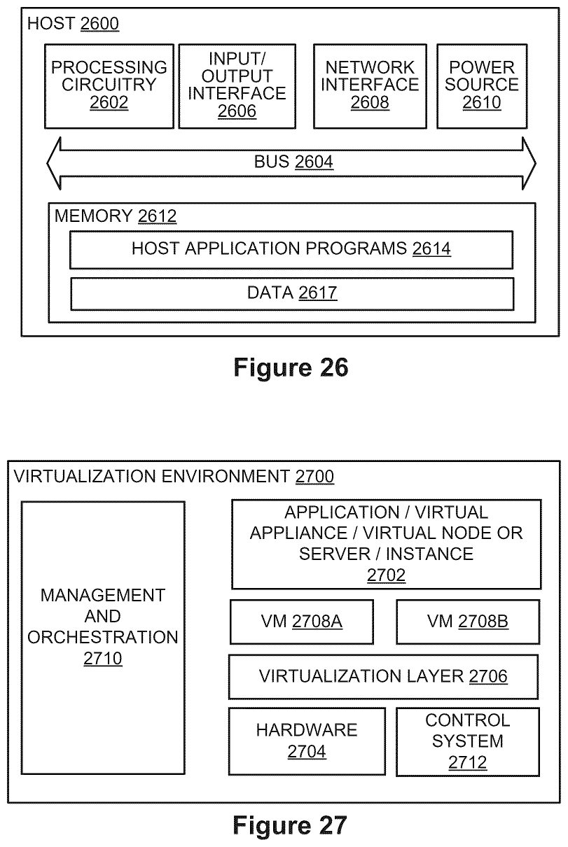

FIG. 26 is a block diagram of a host 2600, which may be an embodiment of the host 2316 of FIG. 23, in accordance with various aspects described herein. As used herein, the host 2600 may be or comprise various combinations hardware and/or software, including a standalone server, a blade server, a cloud-implemented server, a distributed server, a virtual machine, container, or processing resources in a server farm. The host 2600 may provide one or more services to one or more UEs.

The host 2600 includes processing circuitry 2602 that is operatively coupled via a bus 2604 to an input/output interface 2606, a network interface 2608, a power source 2610, and a memory 2612. Other components may be included in other embodiments. Features of these components may be substantially similar to those described with respect to the devices of previous figures, such as FIGS. 24 and 25, such that the descriptions thereof are generally applicable to the corresponding components of host 2600.

The memory 2612 may include one or more computer programs including one or more host application programs 2614 and data 2616, which may include user data, e.g., data generated by a UE for the host 2600 or data generated by the host 2600 for a UE. Embodiments of the host 2600 may utilize only a subset or all of the components shown. The host application programs 2614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2614 may also provide for user authentication and licensing checks and may periodically report health, routes, and content availability to a central node, such as a device in or on the edge of a core network. Accordingly, the host 2600 may select and/or indicate a different host for over-the-top services for a UE. The host application programs 2614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 27 is a block diagram illustrating a virtualization environment 2700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2702 (which may alternatively be called software instances, virtual appliances, network functions, virtual nodes, virtual network functions, etc.) are run in the virtualization environment 2700 to implement some of the features, functions, and/or benefits of some of the embodiments disclosed herein.

Hardware 2704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2706 (also referred to as hypervisors or virtual machine monitors (VMMs)), provide VMs 2708A and 2708B (one or more of which may be generally referred to as VMs 2708), and/or perform any of the functions, features and/or benefits described in relation with some embodiments described herein. The virtualization layer 2706 may present a virtual operating platform that appears like networking hardware to the VMs 2708.

The VMs 2708 comprise virtual processing, virtual memory, virtual networking or interface and virtual storage, and may be run by a corresponding virtualization layer 2706. Different embodiments of the instance of a virtual appliance 2702 may be implemented on one or more of VMs 2708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2708 may be a software implementation of a physical machine that runs programs as if they were executing on a physical, non-virtualized machine. Each of the VMs 2708, and that part of hardware 2704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2708 on top of the hardware 2704 and corresponds to the application 2702.

Hardware 2704 may be implemented in a standalone network node with generic or specific components. Hardware 2704 may implement some functions via virtualization. Alternatively, hardware 2704 may be part of a larger cluster of hardware (e.g., such as in a data center or CPE) where many hardware nodes work together and are managed via management and orchestration 2710, which, among others, oversees lifecycle management of applications 2702. In some embodiments, hardware 2704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2712 which may alternatively be used for communication between hardware nodes and radio units.

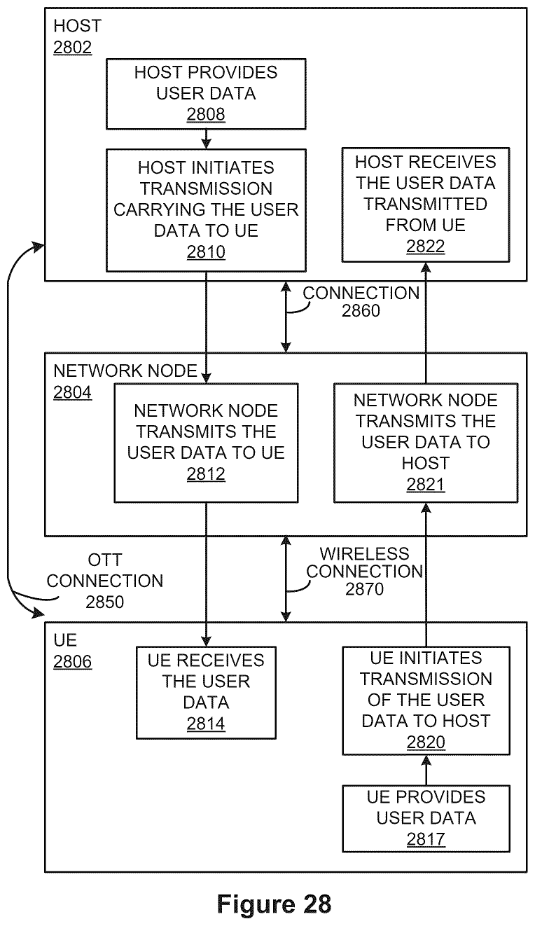

FIG. 28 shows a communication diagram of a host 2802 communicating via a network node 2804 with a UE 2400 over a partially wireless connection in accordance with some embodiments. Example implementations, in accordance with various embodiments, of the UE (such as a UE 2312A of FIG. 23 and/or UE 2400 of FIG. 24), network node (such as network node 2310A of FIG. 23 and/or network node 2500 of FIG. 25), and host (such as host 2316 of FIG. 23 and/or host 2600 of FIG. 26) discussed in the preceding paragraphs will now be described with reference to FIG. 28.

Like host 2600, embodiments of host 2802 include hardware, such as a communication interface, processing circuitry, and memory. The host 2802 also includes software, which is stored in or accessible by the host 2802 and executable by the processing circuitry. The software includes a host application that may be operable to provide a service to a remote user, such as the UE 2400 connecting via an over-the-top (OTT) connection 2850 extending between the UE 2400 and host 2802. In providing the service to the remote user, a host application may provide user data which is transmitted using the OTT connection 2850.

The network node 2804 includes hardware enabling it to communicate with the host 2802 and UE 2400. The connection 2860 may be direct or pass through a core network (like core network 2306 of FIG. 23) and/or one or more other intermediate networks, such as one or more public, private, or hosted networks. For example, an intermediate network may be a backbone network or the Internet.

The UE 2400 includes hardware and software, which is stored in or accessible by UE 2400 and executable by the UE's processing circuitry. The software includes a client application, such as a web browser or operator-specific “app” that may be operable to provide a service to a human or non-human user via UE 2400 with the support of the host 2802. In the host 2802, an executing host application may communicate with the executing client application via the OTT connection 2850 terminating at the UE 2400 and host 2802. In providing the service to the user, the UE's client application may receive request data from the host's host application and provide user data in response to the request data. The OTT connection 2850 may transfer both the request data and the user data. The UE's client application may interact with the user to generate the user data that it provides to the host application through the OTT connection 2850.

The OTT connection 2850 may extend via a connection 2860 between the host 2802 and the network node 2804 and via a wireless connection 2870 between the network node 2804 and the UE 2400 to provide the connection between the host 2802 and the UE 2400. The connection 2860 and wireless connection 2870, over which the OTT connection 2850 may be provided, have been drawn abstractly to illustrate the communication between the host 2802 and the UE 2400 via the network node 2804, without explicit reference to any intermediary devices and the precise routing of messages via these devices.

As an example of transmitting data via the OTT connection 2850, in step 2808, the host 2802 provides user data, which may be performed by executing a host application. In some embodiments, the user data is associated with a particular human user interacting with the UE 2400. In other embodiments, the user data is associated with a UE 2400 that shares data with the host 2802 without explicit human interaction. In step 2810, the host 2802 initiates a transmission carrying the user data towards the UE 2400. The host 2802 may initiate the transmission responsive to a request transmitted by the UE 2400. The request may be caused by human interaction with the UE 2400 or by operation of the client application executing on the UE 2400. The transmission may pass via the network node 2804, in accordance with the teachings of the embodiments described throughout this disclosure. Accordingly, in step 2812, the network node 2804 transmits to the UE 2400 the user data that was carried in the transmission that the host 2802 initiated, in accordance with the teachings of the embodiments described throughout this disclosure. In step 2814, the UE 2400 receives the user data carried in the transmission, which may be performed by a client application executed on the UE 2400 associated with the host application executed by the host 2802.

In some examples, the UE 2400 executes a client application which provides user data to the host 2802. The user data may be provided in reaction or response to the data received from the host 2802. Accordingly, in step 2816, the UE 2400 may provide user data, which may be performed by executing the client application. In providing the user data, the client application may further consider user input received from the user via an input/output interface of the UE 2400. Regardless of the specific manner in which the user data was provided, the UE 2400 initiates, in step 2818, transmission of the user data towards the host 2802 via the network node 2804. In step 2820, in accordance with the teachings of the embodiments described throughout this disclosure, the network node 2804 receives user data from the UE 2400 and initiates transmission of the received user data towards the host 2802. In step 2822, the host 2802 receives the user data carried in the transmission initiated by the UE 2400.

In an example scenario, factory status information may be collected and analyzed by the host 2802. As another example, the host 2802 may process audio and video data which may have been retrieved from a UE for use in creating maps. As another example, the host 2802 may collect and analyze real-time data to assist in controlling vehicle congestion (e.g., controlling traffic lights). As another example, the host 2802 may store surveillance video uploaded by a UE. As another example, the host 2802 may store or control access to media content such as video, audio, VR or AR which it can broadcast, multicast or unicast to UEs. As other examples, the host 2802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2850 between the host 2802 and UE 2400, in response to variations in the measurement results. The measurement procedure and/or the network functionality for reconfiguring the OTT connection may be implemented in software and hardware of the host 2802 and/or UE 2400. In some embodiments, sensors (not shown) may be deployed in or in association with other devices through which the OTT connection 2850 passes; the sensors may participate in the measurement procedure by supplying values of the monitored quantities exemplified above, or supplying values of other physical quantities from which software may compute or estimate the monitored quantities. The reconfiguring of the OTT connection 2850 may include message format, retransmission settings, preferred routing etc.; the reconfiguring need not directly alter the operation of the network node 2804. Such procedures and functionalities may be known and practiced in the art. In certain embodiments, measurements may involve proprietary UE signaling that facilitates measurements of throughput, propagation times, latency and the like, by the host 2802. The measurements may be implemented in that software causes messages to be transmitted, in particular empty or ‘dummy’ messages, using the OTT connection 2850 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

### REFERENCES ARE IDENTIFIED BELOW

1. 3GPP TS 38.300 v16.1.0 (2020-03); 3^{rd} Generation Partnership Project; Technical Specification Group Radio Access Network; NR; NR and NG-RAN Overall Description; Stage 2 (Release 16)
2. RP-213585 WID on NR sidelink relay enhancements

1. A method in a user equipment, UE, for scheduling a group data transmission in a group of devices referred to as group devices, the method comprising:
transmitting data to the group devices over a sidelink at a first time;
transmitting a minimum radio quality threshold to the group devices with the data for each group device to compare the group device's quality to the minimum radio quality threshold at a coordinated transmission time; and
cooperatively transmitting the data towards a network node at the coordinated transmission time based on the group device quality being above the minimum radio quality threshold on either a configured grant or a dynamically scheduled grant.

2. The method of claim 1, further comprising transmitting an indication of which measurement to use for comparing the group device quality to the minimum radio quality threshold.

3. The method of claim 1, further comprising:
obtaining a required total signal to interference plus noise ratio, SINR;
receiving measurements and/or parameters from devices in the group devices;
determining a transmission scheme that reaches the required total SINR and defines which devices of the group devices to participate in the group data transmission and a number of retransmissions to be used in transmitting the data; and
transmitting an indication to devices of the group devices that indicate at least one of:
indicate that the device does not need to participate in the coordinated transmission; or
indicate that the device may participate in the coordinated transmission.

4. The method of claim 3, wherein receiving the measurements and/or parameters comprises receiving measurements and/or parameters in the form of:
radio quality measurements;
battery status; and
maximum allowed number of retransmissions.

5. The method of claim 4, wherein determining the transmission scheme comprises:
sorting the group devices with respect to priority to save battery into high, medium and low priority groups wherein the high priority group comprises group devices with a highest need to save battery.

6. The method of claim 5, wherein determining the transmission scheme comprises:
receiving uplink SINR, UL SINR, from the network node; and
sorting the UL SINR of the group devices with low priority to save battery.

7. The method of claim 5, wherein determining the transmission scheme comprises:
translating or mapping the radio quality measurements to uplink SINR, UL SINR; and
sorting the UL SINR of group devices with low priority to save battery.

8. The method of claim 5, wherein determining the transmission scheme comprises:
starting with group devices with a highest UL SINR in the group devices with low priority to save battery, summing the individual SINR for the group devices until the sum is at least the required total SINR.

9. The method of claim 8, further comprising:
responsive to group devices needed to reach the required total SINR contain group devices that need to save battery, repeating sorting of UL SINR of the group devices with low priority to save battery with an additional retransmission provided that the addition of the additional transmission is less than the maximum allowed number of retransmissions.

10. The method of claim 8, further comprising:
responsive to the required total SINR not being reached, adding group devices with a next priority to save battery and repeating the sorting, summing, and repeating with the group devices with the next priority included in the sorting, summing, and repeating.

11. The method of claim 3, wherein transmitting the indication to devices of the group devices comprises:
implementing a bitmap broadcast to transmit the indication.

12. The method of claim 3, wherein the indication indicates that the group device may participate in the coordinated transmission and transmitting the indication to devices of the group devices comprises
responsive to devices of the group devices having a same priority to save battery, transmitting the minimum radio quality threshold to the devices of the group devices wherein each device of the group devices receiving the indication determines whether to take part in the coordinated transmission.

13. A method in a user equipment, UE, for participating in a group data transmission in a group of devices referred to as group devices, the method comprising:
receiving data from a coordinator group device over a sidelink at a first time;
receiving a minimum radio quality threshold;
comparing a quality of the UE to the minimum radio quality threshold at a coordinated transmission time;
determining whether to transmit the data towards a network node at the coordinated transmission time based on the quality of the UE being above the minimum radio quality threshold; and
responsive to determining to cooperatively transmit the data, transmitting the data towards a network node at the coordinated transmission time.

14. The method of claim 13, further comprising:
responsive to the coordinator group device controlling uplink scheduling, transmitting measurements and/or parameters to the coordinator group device in the form of:
radio quality measurements;
battery status; and
maximum allowed number of retransmissions; and
responsive to the network node controlling uplink scheduling, transmitting measurements and/or parameters to the network node or via the coordinator group device in the form of battery status.

15. The method of claim 13, further comprising:
receiving an indication indicating no need to participate in the coordinated transmission; and
responsive to receiving the indication, foregoing participating in the coordinated transmission.

16. (canceled)

17. The method of claim 12, wherein determining whether to transmit the data towards a network node at the coordinated transmission time comprises determining whether to transmit the data towards a network node at the coordinated transmission time based on the quality of the UE being above the minimum radio quality threshold at the coordinated transmission time and not receiving the indication of no need to participate in the coordinated transmission.

18. A method in a network node for scheduling a group data transmission in a group of devices referred to as group devices, the method comprising:
receiving battery status from devices in the group devices;
determining a transmission scheme that defines which devices of the group devices that participate in the group data transmission and a number of retransmissions to be used in transmitting the data; and
transmitting an indication to devices of the group devices that indicate at least one of:
indicate that the device does not need to participate in the coordinated transmission; or
indicate that the device may participate in the coordinated transmission; and
scheduling the uplink coordinated transmission time for the group devices.

19. (canceled)

20. The method of claim 19, wherein determining the transmission scheme comprises:
sorting the uplink, UL, signal to interference plus noise ratio, SINR, of the group devices with low priority to save battery.

21. The method of claim 20, wherein determining the transmission scheme comprises:
starting with the group devices having a highest UL SINR of the group devices with low priority to save battery, summing the individual SINR for the group devices until the sum is at least a required total SINR.

22. The method of claim 21, further comprising:
responsive to group devices needed to reach the required total SINR contain group devices that need to save battery, repeating sorting of UL SINR of the group devices with low priority to save battery with an additional retransmission provided that the addition of the additional transmission is less than the maximum allowed number of retransmissions.

23.-33. (canceled)
